(19) United States
(12) Patent Application Publication
(10) Pub. No.: US 2014/0164958 A1
(43) Pub. Date: Jun. 12, 2014

(54) System, Method and Interface for Displaying Content

(71) Applicants: April Slayden Mitchell, San Jose, CA (US); Kurt W. MacDonald, Hollywood, CA (US); Ian N. Robinson, Pebble Beach, CA (US)

(72) Inventors: April Slayden Mitchell, San Jose, CA (US); Kurt W. MacDonald, Hollywood, CA (US); Ian N. Robinson, Pebble Beach, CA (US)

(21) Appl. No.: 14/129,978

(22) PCT Filed: Jun. 30, 2011
(86) PCT No.: PCT/US2011/042702

§ 371 Date: Dec. 29, 2013

(51) Int. Cl. H04L 29/06; H04N 7/15

(52) U.S. Cl. CPC H04L 65/403; H04N 7/15
USPC 715/753

(57) ABSTRACT

A user interface for displaying content, a user interface being comprised of n workspace boards 110a-n. Each workspace board has an area defined by a first edge 112a-n and a second edge 114a-n. Each workspace board has board availability indicator 120a-n. Each workspace board area is capable of being moved on and off of a display screen 124. When the workspace board area is moved off of the display screen—the board availability indicator associated with the workspace board remains on the display screen. When the workspace board area is off of the display screen, movement of the board availability indicator associated with the off screen workspace board moves the launch location of the workspace board.

### BACKGROUND

In video-conferencing systems, the whiteboard or shared surface is often positioned next to the remote party's video. For video conferencing where the desktop is shared, a selected screen may be designated for sharing and content may originate or be pulled onto the designated shared screens. Some systems allow users viewing the shared content to change the state from other systems participating in the conference. For example, the system might allow participants in a conference to resize the display and its contents or to provide control to the participants to open or close the presentation, etc. These control privileges allow video conference participants to view different content.

### BRIEF DESCRIPTION OF DRAWINGS

The figures depict implementations/embodiments of the invention and not the invention itself. Some embodiments are described, by way of example, with respect to the following Figures.

FIG. 1 illustrates a block diagram of a system supporting a sliding board user interface for sharing content according to an example of the invention;

FIG. 2A shows movement of a board availability indicator from a first location to a second location in a desktop computing environment according to an example of the invention;

FIG. 2B shows the sliding board interface in FIG. 2A where the board associated with the board availability indicator moved to the second location is opened according to an example of the invention;

FIG. 3A illustrates a sliding board interface in a desktop computing environment where the workspace board is being opened according to an example of the invention;

FIG. 3B illustrates a sliding board interface in a desktop computing environment where the workspace board is being moved from a first location on one side of the display to another location on the opposite side of the display according to an example of the invention;

FIG. 3C illustrates a sliding board interface in a desktop computing environment after moving the location of the workspace board to the opposite side of the display according to an example of the invention;

FIG. 4A illustrates a sliding board interface in a desktop computing environment where two overlapping workspace boards are open according to an example of the invention;

FIG. 4B illustrates the sliding board interface shown in FIG. 4A where the workspace boards are being moved off of the display screen of the desktop computer according to an example of the invention;

FIG. 4C illustrates a sliding board interface shown in FIG. 4B where the two workspace boards are both moved off screen according to an example of the invention;

FIG. 5A illustrates a flow diagram of a method of displaying content via a sliding board interface display according to an example of the present invention;

FIG. 5B illustrates a flow diagram of a method of displaying content via a sliding board interface display according to an example of the present invention;

FIG. 6 shows a computer system for implementing the method shown in FIGS. 5A-5B described in accordance with examples of the present invention.

The drawings referred to in this Brief Description should not be understood as being drawn to scale unless specifically noted.

### DETAILED DESCRIPTION OF EMBODIMENTS

For simplicity and illustrative purposes, the principles of the embodiments are described by referring mainly to examples thereof. In the following description, numerous specific details are set forth in order to provide a thorough understanding of the embodiments. It will be apparent, however, to one of ordinary skill in the art, that the embodiments may be practiced without limitation to these specific details. Also, different embodiments may be used together. In some instances, well known methods and structures have not been described in detail so as not to unnecessarily obscure the description of the embodiments.

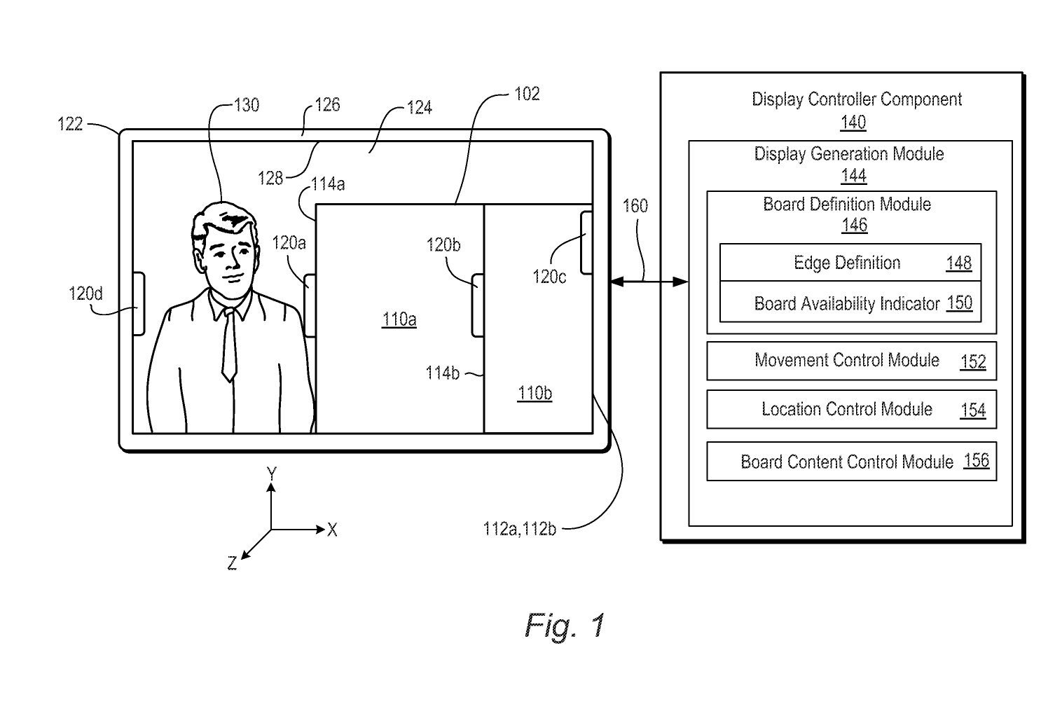

Referring to FIG. 1 illustrates a sliding board user interface in a large display video conference configuration according to an example of the invention. The user interface for displaying content, the user interface comprised of: n workspace boards 110a-n, each workspace board area having an area defined by a first edge 112a-n and a second edge 114a-n and a board availability indicator 120a-n, each workspace board area capable of being moved on and off of a display screen 124, wherein when the workspace board area is moved off the display screen the board availability indicator associated with the workspace board remains on the display screen, wherein when the workspace board area is off of the display screen, movement of the availability indicator associated with the off screen workspace board on the display screen moves the launch location of the workspace board.

The user interface 102 for sharing content on a display is comprised of: n workspace boards 110a-n, each of the n workspace boards capable of being in an open on screen position or a closed off screen position. In the example shown in FIG. 1, n workspace boards are shown as being available, where n is an integer value greater than or equal to one. For the example shown in FIG. 1, the value of n is equal to four. However, in the example shown in FIG. 1 although four workspace boards are available—only two of the four available boards are on screen and open. Because only two workspace boards (110a, 110b) are open, only the workspace board areas of boards 110a and 110b have a workspace board area that is viewable by the participants viewing the display. By open, we mean that the workspace board area is (1) on the display screen and visible to the viewers of the display and (2) available for the workspace board users to modify or otherwise interact with. By the term user or workspace board user, we mean a user of the system that has the ability to both view the content on the display and also to modify the position (open/close), location, status (save, erase) or content on the workspace board.

Referring to FIG. 1, two of the four workspace boards are off screen in a closed position. By closed we mean that the workspace board area associated with a board availability indicator is off screen. When a workspace board is in a closed position, the board availability indicator shows that a board is available for use/launching—but the workspace board is not available to the content board user to modify (add/delete content from) or otherwise interact with content. When the workspace board is closed and off screen, the content on the workspace board area is not available to interact with—only the board availability indicator (handle) is visible and available to open or close the workspace board. In the example shown in FIG. 1, for the closed workspace boards 110c and 110d the area of the workspace board is not shown—the only indicator of the presence of boards 110c and 110d are the board availability indicators 120c and 120d.

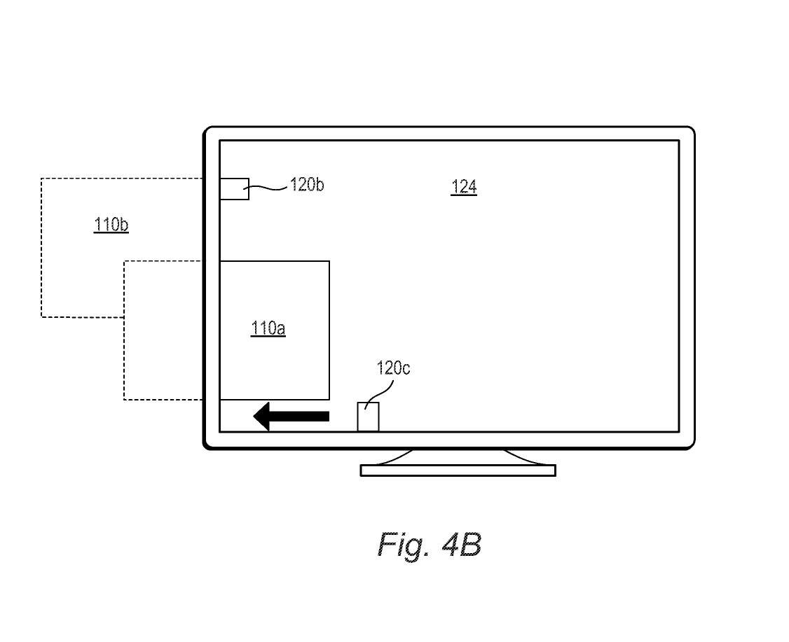

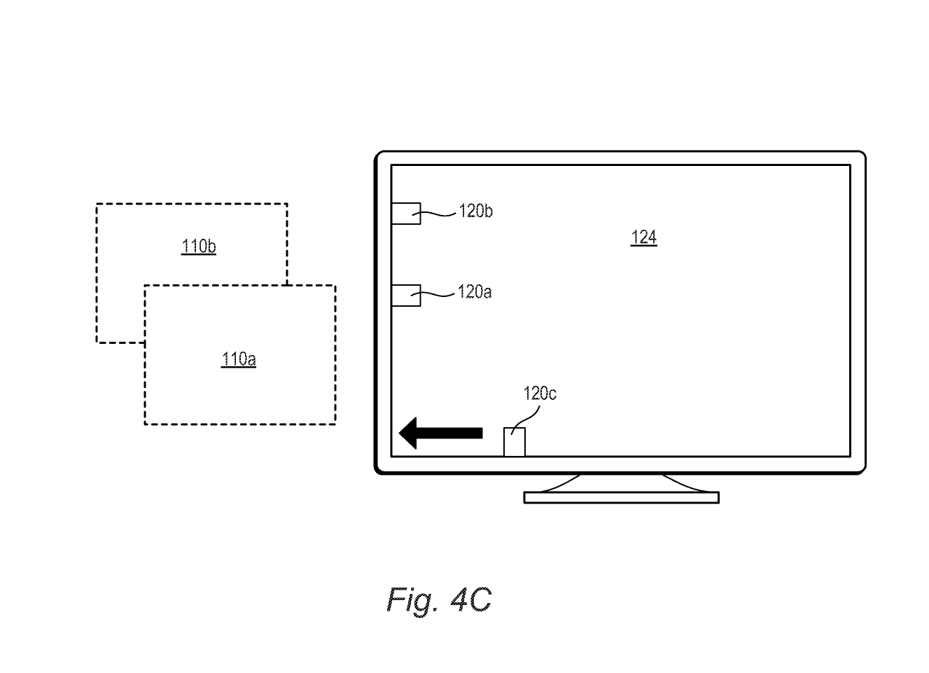

Since the workspace board area is not visible to the workspace board user(s) or others viewing the display—only the board availability indicator 120a-n docked to the edge of the display may be seen. One way of describing the closed board is that although the closed workspace boards exist and are available if opened or launched, the closed boards are off screen so that they are obscured or hidden to the viewers of the display. An example of an off screen board can be more clearly seen with reference to the example shown in FIG. 4B. As the board availability indicator 120a-n or handle is pulled, slowly more and more of the workspace board is moved or revealed—dependent on the direction the workspace board area is being pulled. Another way of describing the closed workspace board is with reference to its two edges (a first origination edge and a second termination edge) both associated with the board availability indicator. However, because the workspace board hasn't yet been opened—the first origination edge and the second termination edge are coincident. They overlap each other which essentially makes it looks like the two edges are collapsed similar to a bi-folding door.

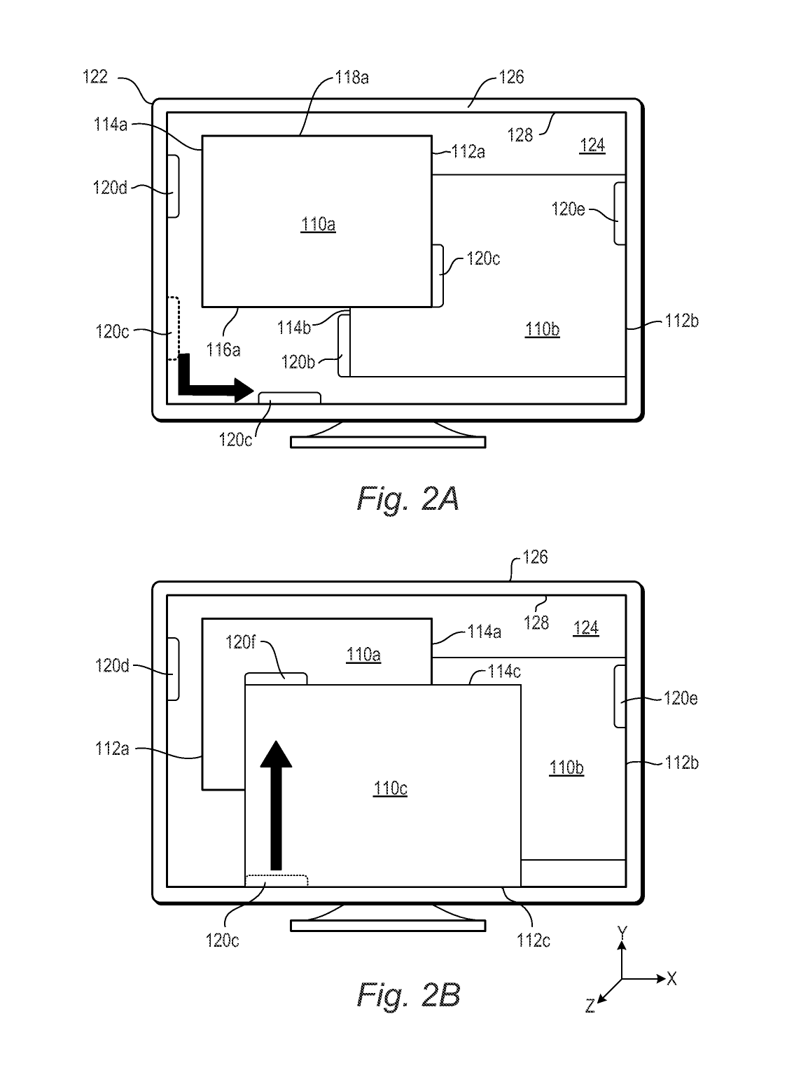

Each of the on screen open workspace boards includes a first origination edge 112a-n and a second termination edge 114a-n. The workspace board area is the area inside of the workspace associated with the board availability indicator. With reference to FIG. 2A for example, the area of the workspace board 110a is defined by the edges of the rectangular workspace: the first and second edges (112a and 114a) and also the third and fourth edges (116a and 118a).

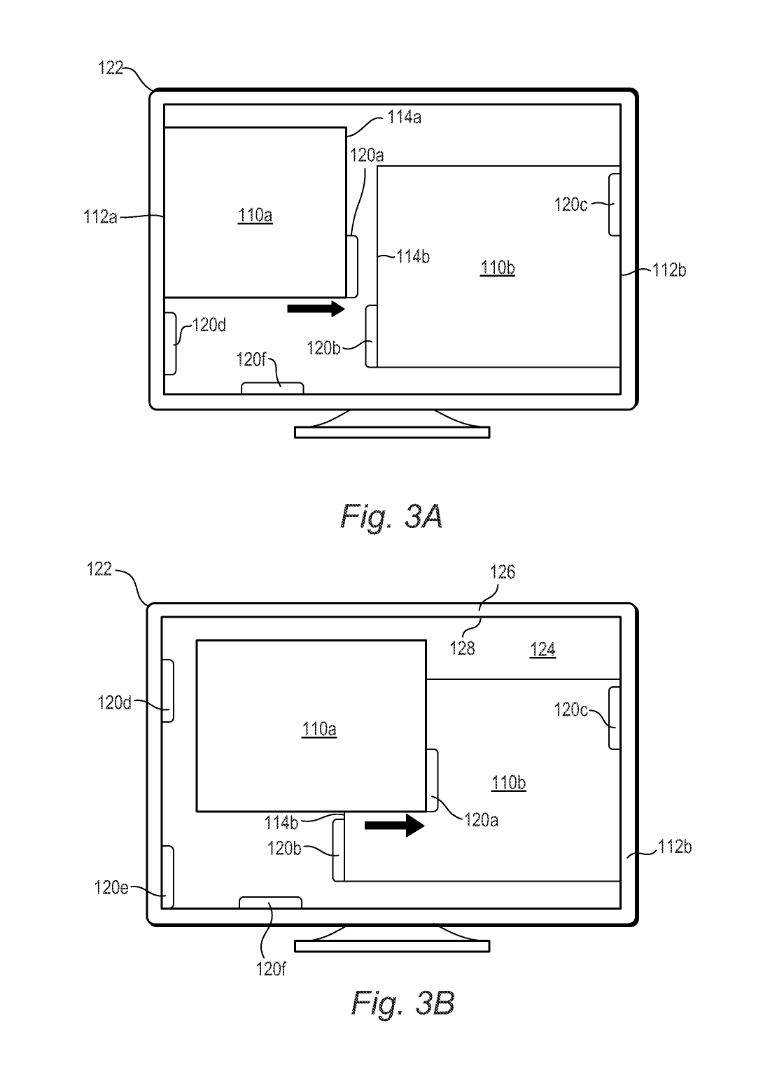

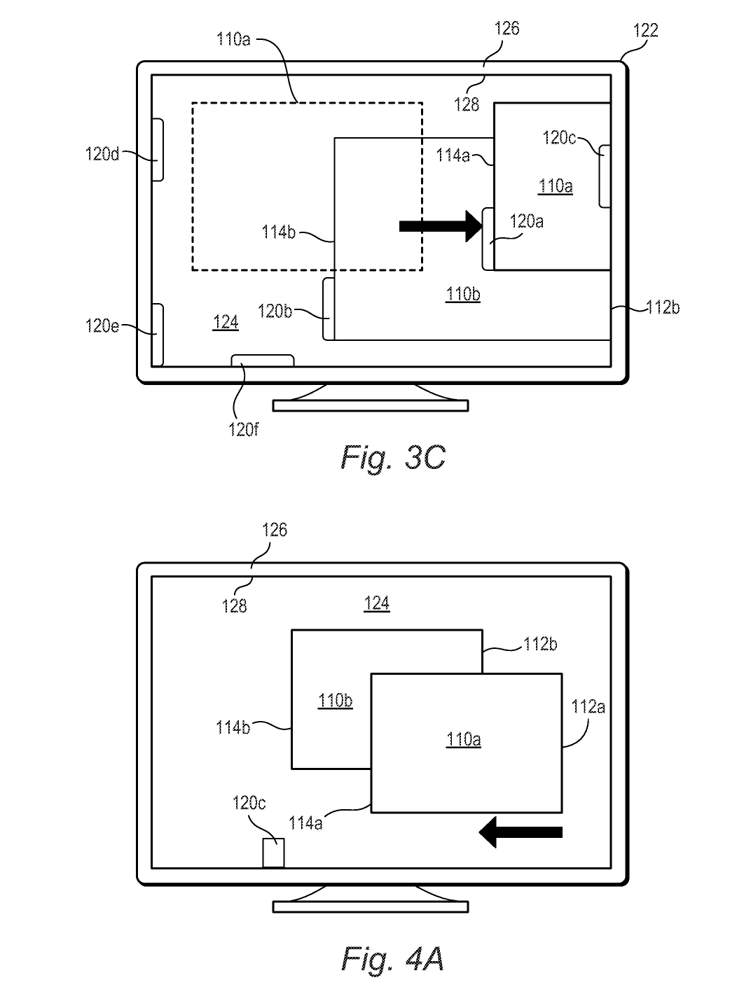

The first origination edge 112a-n indicates the location that the workspace board originates from and the second termination edge 114a-n indicates where the workspace board terminates. For the case where the workspace board is described with respect to its two edges, the second termination edge can be described as moveable. Thus for example, referring to the implementation shown in FIG. 3A as the edge 114a is pulled via the handle 120a, the second edge moves in the direction of the arrow shown on screen.

In the examples shown in FIGS. 1, 2A-2B, and 3A-3C, the board availability indicator is a handle. In one example, for the case of an open board—the board availability indicator 120a-n is positioned along the second termination edge 114a-n. For the case where the board is dosed and off screen (120c and 120d), in one example, the board availability indicator is anchored or docked to the edge of the display screen. If the board availability indicator is pulled to open or launch the workspace board, the workspace board area opens from the location of the board availability indicator—the edge of the display screen.

As previously noted, in one example the off screen boards are represented only by the board availability indicator. In one example, the handle is docked or anchored to the perimeter of the display. The board availability indicator with respect to the off screen workspace board can be used to represent either (1) a new board that has never been opened and is available to be opened or (2) alternatively to represent a board that has been previously opened and may or may not have content associated with it.

Although in the example shown in FIG. 1, a handle is shown to indicate the availability of a sliding workspace board, other indicators of the availability of a sliding board interface could be used. For the case where content has been added to the board, a thumbnail image of the workspace boards could be used to indicate the availability of a workspace board 110a-n. In one example, a thumbnail image of a board or a plurality of boards could be associated with each handle and used to indicate the availability of a board. The thumbnail images could be located along the edge of the display screen. In another example, the thumbnail images could be located on the handles. In one example, the board availability indicator could be a text list of the available boards. In another example, a timeline of previously created boards of dates and times in chronological order could list the available boards. Touching or clicking on the text of any of the listings in one example, could summon the corresponding workspace board.

Each board availability indicator 120a-n or handle could be associated with an identifier which lets the users (130 for example) or viewer of the content more easily identify the content on the board when the board is closed or contracted so that the entire board content area is not fully extended. For example, as previously described a thumbnail image of the board contents could be overlaid on the handle associated with the board. Alternatively, thumbnail images associated with the board could appear responsive to a user running their fingers (or mouse) over the thumbnail images. In one example, a photo image of the user(s) who creates the content could be associated with the board handle so that the source of the content creation is known. Alternatively, a color could be associated with the user creating the content. In another example, the workspace board could be associated with a descriptive title entered by the system or user.

In the example shown in FIG. 1, two board availability indicators 120a and 120b are associated with open boards and board availability indicators 120c and 120d are associated with available but closed boards. In the example shown in FIG. 1, the board availability indicators are handles that can be pulled to the left or right at the preference of the owner. When handles 120a, 120b, 120c are pulled to the left the workspace surface more of the workspace board area is moved onto the display screen and when the handle is pulled to the right—less of the workspace board area is shown on the display screen. When the handle 120d is pulled to the right a new workspace board area opens and as the handle is moved further to the right—more of the workspace area of the board associated with handle 120d is displayed.

Referring to FIG. 1 shows an implementation with four available boards. In one example, once a board is opened, a new board handle is automatically generated. In one example, wherever the user opens the prior board, the handle originates from the same edge and successive boards are on the same track (travels linearly along the same width or height) in the same orientation. In one example, the newly generated handle appears at the same edge in the same location where the last board that was opened. In an alternative example (and as shown in FIG. 1), the height of the newly generated handle is at the same edge but at a slight different location (slightly higher height) than the previous handle. In one example, the board availability indicators do not overlap to prevent them from obscuring other board availability indicators, also docked availability indicators are never occluded by open boards so that dosed boards are always accessible.

When a new board is opened, the next handle is automatically generated as if the system is pulling boards from an infinite queue. Although in theory, n can be an infinite number and an infinite number of boards can be pulled. In reality the number of boards available is limited by the memory and processing capability of the system 140 and it's supporting network. In one example, the number of boards available can be set by the workspace board user or the system.

As space of the display screen 124 may be limited, the plurality of boards 110a-n opened may appear to be layered or stacked. In one example, the default is that boards opening later in time appear on top of the earlier boards. Thus if the areas they extend into overlap, the board that opens later in time will occlude the earlier opened boards. For conferencing solutions, the stacked boards will appear in the same order for the local and remote users. For example, if the local user opens a board having the same tracks as a previous board, then the second board will appear on top of the other board to both the local and remote users.

Referring to FIG. 1, in one example, the board 110b is opened later in time than board 110a and will occlude 110a as it extends further. In FIG. 1, the second board 110b is shown open but slightly offset. As the number of open boards increases, it becomes increasingly difficult to organize and manipulate the boards so that they can be easily viewed. One solution is to organize the boards slightly offset in a stadium configuration such that one group of boards is on a first level closest to the user, and other groups of boards are on other levels, each level visually slightly further back. Rather than having occlusion prevent the user from easily seeing or interacting with the board, the stadium configuration allows the user to more easily manipulate boards at all the different levels.

With respect to the open boards 110a, 110b on the display screen, the first origination edge 112a, 112b indicates the location that the workspace board originates from. Thus with reference to FIG. 1 the workspace board 110a originated from the edge 112a and the content board 110b originated from the edge 112b. The second termination edge 114a, 114b indicates where the workspace board terminates. Movement of the second termination edge 114a-b modifies the size of the workspace board area that is viewable on the display. Unless, movement of the second termination edge is greater than the maximum size of the workspace board, the origination edge 114a-b remain fixed in order to origination or dock the board to the location of the originating first edge while the workspace area expands as the board moves to the left with respect to boards 110a and 110b. In contrast, the area of the workspace board contracts or slides off the display screen when moving the second termination board edge to the right with respect to boards 110a and 110b. Thus, the second termination edge modifies the workspace board area that is viewable by the participants.

Moving the workspace board area can be achieved, for example, by using a mouse to drag the handle to the desired location. Alternatively, on a touch sensitive display, the owner could touch the handle and slide it to the desired location. Alternatively, a gesture such as the user putting the palm of their hand on (flat hand pressed against full palm) or near the surface of the display and sliding it to the desired termination location could be used. In addition, shortcuts to close or open a board could be implemented using, for example, a double tap or a swipe gesture on the handle.

Referring to FIG. 1, when open and being moved from one position to another on the display screen—the movement of the workspace board is along a linear path. By the term along a linear path we mean that if a point was defined, for example, on the second termination edge as the point moves as the board handle is pulled, the movement of the point would form a line. The linear motion makes the board appear to be sliding out from behind the perimeter of the display screen—thus the reference to the sliding board interface. For example, for the board 110a if the handle 120a were moved to the right to decrease the area of the workspace board (or to close the board), the linear path would be a straight line parallel to the x axis. Although in the board placements shown in FIGS. 1-4, the linear path is a line parallel to the x or y axes, in one example (not shown) the linear path could be at an angle with the display perimeter. For example, a handle could be placed in the corner of the display so that when pulled upwards (or downwards), the linear path formed a 45 degree angle with the corner of the display.

FIG. 1 illustrates a sliding board user interface in a large screen video display environment according to an example of the invention. In the system shown in FIG. 1, the shared surface (workspace board) is blended on top of the remote participant's video creating a content “in between” the users. FIG. 1 is shown from perspective of a local video conference participant viewing the workspace board. The local video conference participant see the remote video conference participant 130 on the other side of the shared board. Unless marked private, the content on the open workspace boards that is viewed by both the local and remote participants appears identical.

In one example, the users or participants in the video conference can move and/or resize the workspace boards. For example, in the large screen video wall application shown in FIG. 1, participants (content board users) can choose to stand wherever they want based on the location and size (how far out the content board is pulled) of the content board. when working with other participants on the other side of the board. For example, if several people are participating in the conference and a large workspace area is needed, the workspace users might want to lower the board height so a low board exists across the entire lower surface and the faces of participants can be more easily seen.

Although the sliding board interface shown in FIG. 1 is shown with a large screen video wall conferencing solution—the sliding board interface can also be used with other conferencing solutions or alternatively in other contexts where a display is used to share content. For example, instead of video wall conferencing solution where two video displays share a sliding board interface, the sliding board interface could be used with reference to a variety of combinations of devices that share the content of their display(s). Examples of devices that could be used to share and display content using the sliding board interface include, but are not limited to: desktop computing devices, laptop computing devices, mobile computing devices, etc.

The devices could be used in a conference where video is shared. Alternatively, the workspace board display could be used in conferencing solutions where video is not shared and content between participants is shared. Although the workspace boards can be used in combination of different devices or a plurality of the same devices and their displays, in one example a single display device may be used. For example, the sliding board interface may be used in conjunction with a single large display screen when a professor shares content on a large display in front of a class that he is teaching. For this case, the display is not used for video conferencing—but instead is used for presentation purposes. Thus, there may be single or multiple users interacting with the sliding board interface. In a conferencing environment, there are often multiple users interacting with the content while for the case of a single presenter, there may be only one user who has the ability to control the content on the workspace boards.

Some systems allow users viewing shared content to change the state from other systems for example, by allowing participants in a conference to resize the display and it contents, to provide control to the participants to open or close the presentation, etc. Although different computing device types may be used and different conferencing or different display configurations used, in one example the display screen seen by the viewers of the display is consistent. In one example, the state of all boards being shared is the same so the boards look the same to every person participating is critical so that all the viewers are looking at the same content. For this example, a circle on my screen should look like look like a circle on your screen and a movement and the result of the movement (i.e. moving the board handle to the right expands the workspace board) on my screen should be mirrored on the screen of other video conference participants

As previously stated, different computing device configurations can be used. For example, instead of the large screen video wall configuration shown in FIG. 1, in FIG. 2A the sliding board interface according to the present invention is shown on a desktop computer display. FIG. 2A shows sliding board interface where board availability indicator 120c is moved from a first location along the perimeter 128 of the display 122 to a second location along the perimeter of the display according to an example of the invention. Referring to FIG. 2A shows a board availability indicator or handle in a first position or location along the leftmost perimeter or edge of the display screen. In one example, the user of the workspace screen can move the location of the board availability indicator. For example, in the example shown, the user moves the location of the handle from the first position (first position of the handle shown in phantom) to a second location. In this example, changing the location of the handle, changes the direction that the board opens from.

FIG. 2B shows a board being opened from the moved board availability indicator 120c according to an example of the invention. After being moved, the handle of board 110c is positioned along the bottom edge of the display perimeter. As the board opens, the second edge 114c of workspace board 110c moves vertically in a positive y direction, expanding the workspace area of board 110c. The arrow is representative of the movement of the handle in the positive y direction.

Boards that originate from the handles on the right and left side of the display perimeter 128 open from and move horizontally with respect to the perimeter edges. However, board availability indicator that are anchored from and originate from the top or bottom sides of the display perimeter move in a vertical (y) direction. Thus, referring to FIGS. 2A and 2B, while the movement of the boards and their handles for boards 110a and 110b are horizontal (x direction), the movement of board 110c is vertical from the bottom of the perimeter of the display screen.

In the described example, the location of the board availability indicator can be used to determine the location that the workspace board is opened from. By moving the board availability indicator, the user can move the location of the board. From the positioning of the handle, the user can determine the direction the board opens from. Thus, the location and position of the board availability indicator gives the user the ability to maneuver and control where the workspace board area will appear on the display screen. For example referring to FIGS. 2A and 2B, moving the handle from the first location to the second location, changes both the location that the board opens or launches from and also the direction the board opens and closes from (of the linear path.)

As previously stated, different computing device and video conferencing or display configurations may utilize the sliding board interface shown in FIG. 1. In the example shown in FIG. 1, the two open boards shown are the same height and originate from the same tracks. What is meant by the same tracks is the linear direction of motion for the workspace boards. Typically, tracks refer to the lowest height and maximum height of the board along the y axis for a board that moves in the x or horizontal direction. For a board that moves in the vertical or y direction, boards moving along the tracks refers to the minimum and maximum width values.

FIG. 3A show a representation of a workspace board in a sliding board interface as it is being opened according to an example of the invention. Referring to FIG. 3A shows a workspace board with that is in the process of being opened. In the example shown in FIG. 3A, the board 110a has a maximum width x1. In the Figure shown in 3A, the board has not reached its maximum value x1. Once the board meets its maximum width (either set by the system or the user), the area of the workspace board cannot expand further. For the example shown in FIGS. 3A and 3B, if the handle 120a continues to be pulled or slid to the right—the left edge (the first origination edge 112a of the workspace board) no longer touches the perimeter 128 of the display 122. FIG. 4B shows the sliding board interface in FIG. 3A after the board 110a has been opened past it's defined maximum width according to an example of the invention. Referring to FIG. 3B, the first origination edge of the workspace board is not touching the perimeter of the display screen—but appears to be floating in the display screen.

In the example shown with respect to FIGS. 3B and 3C, the user continues to move the workspace board towards the right so that it docks on the right hand side of the screen. The user thus will continue to move the board in the x direction until the board touches the perimeter 128 of the display screen. FIG. 3C shows the sliding board interface in FIG. 3B after the workspace board has been moved so that it docks to the right side of the display screen. When the workspace board area and it's handle touches the perimeter of the display screen, the board availability indicator 120a switches sides on the workspace board. Thus, the edge that was previously the termination second edge now touches the perimeter of the display and is now the first origination edge. Similarly; the edge that was previously the origination edge switches and is now the second termination edge. In FIG. 3C, the user is in the process of closing the board. The workspace board no longer has a width of x1 but has decreased ifs width to a width y1.

This system includes a sliding board interface allowing users to create, modify, delete, and save content on multiple boards. In one example, the workspace board created during a session can be saved at any time during the session and reintroduced at a later session. The workspace boards are multi-purpose and can be configured by the user according to need (i.e. whiteboard, images/pictures, slides, web browser, notes page, etc.). The content created for the session can have different functions and different sets of controls depending on their function. For example, if the user brings content onto the board for a slide show presentation—the controls associated with the slide show could be for example, a next slide and previous slide control function. For the example of a whiteboard, the controls associated with the white board could be a paint color function and a function to erase. In one example, each session can be given a URL that is accessible in a browser. Also, each discrete board can be given a URL that it can be accessed from a browser independently.

In one example, content is brought into the session by opening a board and putting the content on the board that the user makes available for display. One option is that when the board is opened, there is a default to present content or controls associated with the default functionality. For example, if the most common implementation was a whiteboard, the default would to be a workspace board that presented the whiteboard functionality. In one example, although a default functionality may be defined, the user or system may modify the default settings.

In one example, the handle or board availability indicator could have some indication of the type of content that is associated with the workspace board. For example, if the content is a sketch board, then a sketch board glyph would be associated with the handle. In addition, in one example, the system would allow the user to scroll through the different content functionalities available. In one example, the user would tap or press and hold the glyph associated with the handle, to get a menu of the icons that could be selected from (i.e. sketch board, web browser, presentation, video, etc.)

The workspace boards can be opened or closed. In one example, the content that is displayed on the workspace board slides with the board. Thus, as the workspace board is closed (moves linearly towards the side of the display screen), the text or content that is visible on the board is obscured or cannot be seen as the point on the workspace board meets the edge of the display screen. In another example, content that displayed on the board is resized to fit the available area remaining on the workspace board. For example, if only ⅓ of the workspace board remains (⅓ of the board size of the workspace board exposed), then the content on the board is automatically—or on demand—resized to fit the remaining exposed board space available.

Boards can be recorded and replayed as video or alternatively can be streamed as live video. The workspace boards can be copied and saved to provide a video playback of the presentation or conferencing session. In one example, workspace boards are copied to provide a simple versioning mechanism. The system could also save snapshots (screen grab of boards) at various key points (e.g. lull in activity, activity changes from local to remote participant (where applicable)) and provide a method to access this “history” for each board. This feature allows the user or other viewer to playback the interactions of the user with the board—providing persistence of the steps.

In some conferencing solutions, the ordering of the content viewed is temporally based. However, in one example of the invention, the ordering is not temporally based. This gives the user the advantage of being able to ability to browse and pull from any previously created or saved workspace boards from the current or previous sessions.

FIG. 4A illustrates a sliding board interface in a desktop computing environment where two overlapping workspace boards are open according to an example of the invention. In the example shown, workspace boards 110a and 110b are in the process of being slid towards the left edge of the display screen and will eventually (see FIGS. 4B and 4C) be moved off screen. As previously discussed with respect to examples shown in FIGS. 2A-2B and 3A-3C, the user can slide the entire workspace boards off screen. Note that in the example shown in FIG. 4A, the boards are not being moved individually by their handles, instead both workspace boards 110a and 110b, are moved for example, by clicking and dragging the display screen 124 outside of either of the boards 110a and 110b or alternatively by dragging the boards using a displayed scroll bar.

Referring to FIG. 4B shows the sliding board 110b being slid so that the workspace board area is entirely off screen. The workspace board and the content associated with it still exist and are represented in phantom outside the frame of the display as if the digital representation of the workspace board was a physical board. As the workspace board 110a and 110b are slid off screen, the corresponding board availability indicator remains on screen. Referring to FIG. 4B shows the workspace board 110b entirely off screen while workspace board 110a is partially on screen and partially off screen. As the board 110b moves off the screen, the corresponding board availability indicator 120b appears on the screen. Thus, in the example shown in 4B and 4C as the workspace board passes off the edge of the display screen, it leaves behind a board availability indicator, for example a thumbnail image) of the workspace board 110b.

FIG. 4C illustrates a sliding board interface as shown in FIG. 4B where the two workspace boards are both closed according to an example of the invention. Referring to FIG. 4C shows the two workspace boards after both workspace boards are off screen. After the second workspace board 110a moves off screen, the board availability indicator 120a corresponding to workspace board 110 appears on screen.

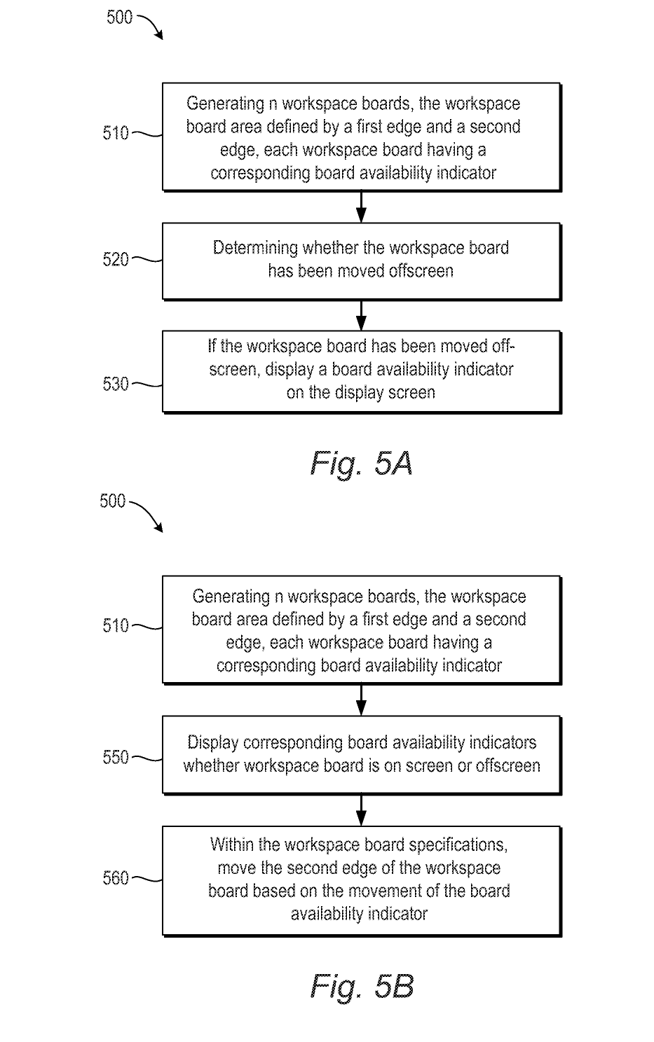

FIGS. 5A and 5B illustrate flow diagrams of a method of displaying content via a sliding board user interface according to an example of the present invention. Referring to FIG. 5, content is shared via a workspace board that is defined by the method 500. The method includes the steps of: determining for an open board, the first origination edge (step 510); determining the second termination edge, wherein the position of the second termination edge is based on the movement and location of the board availability indicator (step 520): and displaying the workspace board (step 530).

Referring to FIG. 1, the display controller component 140 interacts with the display 122 to display the sliding board interface 102 shown. Before the sliding board interface can be displayed, it is first generated by the board generation module 144. The board generation module 146 uses the board definition (defined by the board definition module 146) in order to determine the constraints of the board (for example, defining the board edges as in step 510 and 520 and the board availability). The board size is also in part defined by the movement and location of the second termination edge of the board, which may be moved by the user. The board area can be modified by moving the second termination edge (via the Movement Control Module 152) or the location of the board by moving the board availability indicator (Location Control Module 154). The display controller component 140 communicates with the display (via communications channel 160) to display content (step 530). The content displayed is controlled by the board content control module 156.

FIGS. 5A and 5B illustrates a flow diagrams of a method of displaying content via a sliding board interface user interface according to an example of the present invention. The method of displaying content includes the steps of: generating n workspace boards 110a-n, each workspace board having an area defined by a first edge 112a-n and a second edge 114a-n and an board availability indicator 120a-n, each workspace board capable of being moved on and off of a display screen 124, wherein when the workspace board is moved off the display screen the board availability indicator associated with the workspace board remains on the display screen, wherein movement of the availability indicator on the display screen moves the location of the workspace board; and displaying the n workspace boards.

FIG. 5A illustrates a flow diagram of a method of displaying content via a sliding board interface display according to an example of the present invention. Referring to FIGS. 5A and 5B shows the step of generating a workspace board 510. The workspace board 110a-n is defined by a first edge and a second edge. Each workspace board has a corresponding board availability indicator. After the workspace board has been generated, it is determined whether the workspace board is off screen (step 520). If the workspace board area has been moved off screen, the board availability indicator associated with the workspace board area remains on the screen (step 530).

FIG. 5B illustrates a flow diagram of a method of displaying content via a sliding board interface display according to an example of the present invention. While the flow diagram of FIG. 5A describes a method applicable to the sliding board interfaces described with reference to the implementations shown in FIGS. 2A-2B, 3A-3C and 4A-4C, the flow diagram of FIG. 5A is applicable to the implementations shown in FIGS. 2A-2B and 3A-3C where in one example, the board applicability indicator may be associated with the workspace board when the workspace board is on the display screen. In the examples shown in FIGS. 2A-2B and 3A-3C, the board availability indicator (board handle) is used to pull or slide out the workspace board area and also to move the workspace board to the desired location on the display screen. Thus referring to FIG. 5B, for the example implementations shown in FIGS. 2A-2B and 3A-3C, the corresponding board availability indicators are displayed whether the workspace board is on or off the display screen (step 550). Further, for the workspace boards shown in FIGS. 2A-2B and 3A-3C, the second edge of the workspace board can be moved based on the movement of the board availability indicator. Similar to the embodiment shown in FIG. 4A-4C, the movement or location of the workspace board area is dependent upon the movement or location of the board availability indicator (step 560).

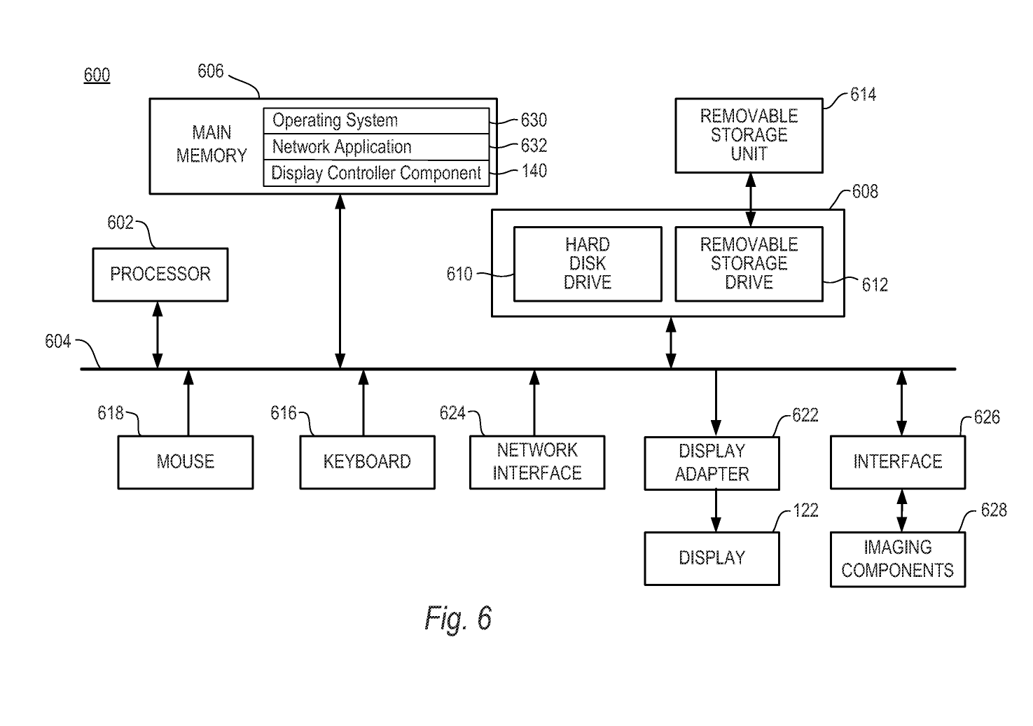

FIG. 6 shows a computer system for implementing the sliding board interface described in FIGS. 1, 2A-B, 3A-C and 4A-C, 5A-5B and described in accordance with examples of the present invention. It should be apparent to those of ordinary skill in the art that the method 500 represents generalized illustrations and that other steps may be added or existing steps may be removed, modified or rearranged without departing from the scopes of the method 500. The descriptions of the method 500 are made with reference to the system 140 illustrated in FIG. 1 and thus refers to the elements cited therein. It should, however, be understood that the method 400 is not limited to the elements set forth in the system 100. Instead, it should be understood that the method 500 may be practiced by a system having a different configuration than that set forth in the system 140.

Some or all of the operations set forth in the method 400 may be contained as utilities, programs or subprograms, in any desired computer accessible medium. In addition, the method 500 may be embodied by computer programs, which may exist in a variety of forms both active and inactive. For example, they may exist as software program(s) comprised of program instructions in source code, object code, executable code or other formats. Any of the above may be embodied on a computer readable medium, which include storage devices and signals, in compressed or uncompressed form.

FIG. 6 illustrates a block diagram of a computing apparatus 600 configured to implement or execute the methods 500 depicted in FIG. 5A-5B and described in accordance with examples of the present invention. In this respect, the display controller component 140 may be used as a platform for executing one or more of the functions described hereinabove.

The computing apparatus 600 includes one or more processor(s) 602 that may implement or execute some or all of the steps described in the methods 500. Commands and data from the processor 602 are communicated over a communication bus 604. The computing apparatus 600 also includes a main memory 606, such as a random access memory (RAM), where the program code for the processor 602, may be executed during runtime, and a secondary memory 608. The secondary memory 608 includes, for example, one or more hard drives 610 and/or a removable storage drive 612, representing a removable flash memory card, etc., where a copy of the program code for the method 400 may be stored. The removable storage drive 612 reads from and/or writes to a removable storage unit 614 in a well-known manner.

These methods, functions and other steps may be embodied as machine readable instructions stored on one or more computer readable mediums, which may be non-transitory. Exemplary non-transitory computer readable storage devices that may be used to implement the present invention include but are not limited to conventional computer system RAM, ROM, EPROM, EEPROM and magnetic or optical disks or tapes. Concrete examples of the foregoing include distribution of the programs on a CD ROM or via Internet download. In a sense, the Internet itself is a computer readable medium. The same is true of computer networks in general. It is therefore to be understood that any electronic device and/or system capable of executing the functions of the above-described examples are encompassed by the present invention.

Although shown stored on main memory 606, any of the memory components described 606, 608, 614 may also store an operating system 630, such as Mac OS, MS Windows, Unix, WebOS or Linux; network applications 632; and a balance control component 634. The operating system 630 may be multiparticipant, multiprocessing, multitasking, multithreading, real-time and the like. The operating system 630 may also perform basic tasks such as recognizing input from input devices, such as a keyboard or a keypad; sending output to the display 620; controlling peripheral devices, such as disk drives, printers, image capture device; and managing traffic on the one or more buses 604. The network applications 632 includes various components for establishing and maintaining network connections, such as software for implementing communication protocols including TCP/IP, HTTP, Ethernet, USB, and FireWire.

The computing apparatus 600 may also include an input devices 616, such as a keyboard, a keypad, functional keys, etc., a pointing device, such as a tracking ball, cursors, etc., and a display(s) 620, such as the LCD screen display 122 shown for example in FIG. 1. A display adaptor 622 may interface with the communication bus 604 and the display 620 and may receive display data from the processor 602 and convert the display data into display commands for the display 620.

The processor(s) 602 may communicate over a network, for instance, a cellular network, the Internet, LAN, etc., through one or more network interfaces 624 such as a Local Area Network LAN, a wireless 802.11x LAN, a 3G mobile WAN or a WiMax WAN. In addition, an interface 626 may be used to receive an image or sequence of images from imaging components 628, such as the image capture device.

The foregoing description, for purposes of explanation, used specific nomenclature to provide a thorough understanding of the invention. However, it will be apparent to one skilled in the art that the specific details are not required in order to practice the invention. The foregoing descriptions of specific examples of the present invention are presented for purposes of illustration and description. They are not intended to be exhaustive of or to limit the invention to the precise forms disclosed. Obviously, many modifications and variations are possible in view of the above teachings. The examples are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

What is claimed is:

1. A user interface for displaying content, the user interface comprised of:
n workspace boards 110a-n, each workspace board having an area defined by a first edge 112a-n and a second edge 114a-n and a board availability indicator 120a-n, each workspace board area capable of being moved on and off of a display screen 124, wherein when the workspace board area is moved off the display screen the board availability indicator associated with the workspace board remains on the display screen, wherein when the workspace board area is off of the display screen, movement of the board availability indicator associated with the off screen workspace board moves the launch location of the workspace board.

2. The user interface recited in claim 1 wherein the board availability indicator is on the display screen when the workspace board is on screen.

3. The user interface recited in claim 2 wherein the board availability indicator is a handle icon.

4. The user interface recited in claim 1 wherein movement of the workspace board is linear.

5. The user interface recited in claim 1 wherein a new board availability indicator automatically appears on the display screen when a workspace board area is opened.

6. A system for displaying content, the system comprising:
A display generation module 144 for generating n workspace boards 110a-n, each workspace board having an area defined by a first edge 112a-n and a second edge 114a-n and a board availability indicator 120a-n, each workspace board area capable of being moved on and off of a display screen 124, wherein when the workspace board area is moved off the display screen the board availability indicator associated with the workspace board remains on the display screen, wherein when the workspace board area is off of the display screen, movement of the board availability indicator associated with the off screen workspace board on the display screen moves the launch location of the workspace board; and
A display, the display including a display screen 124, wherein the display is coupled to the display generation module.

7. The user interface recited in claim 6 wherein the board availability indicator is on the display screen when the workspace board is on screen.

8. The user interface recited in claim 7 wherein the board availability indicator is a handle icon.

9. The user interface recited in claim 6 wherein movement of the workspace board is linear.

10. The user interface recited in claim 6 wherein a new board availability indicator automatically appears on the display screen when a workspace board area is opened.

11. A non-transitory computer readable storage medium having computer readable instructions stored thereon for causing a computer system to perform instructions comprising the steps of;
Generating n workspace boards 110a-n, each workspace board having an area defined by a first edge 112a-n and a second edge 114a-n and aboard availability indicator 120a-n, each workspace board area capable of being moved on and off of a display screen 124, wherein when the workspace board area is moved off the display screen the board availability indicator associated with the workspace board remains on the display screen, wherein when the workspace board area is off of the display screen, movement of the board availability indicator associated with the off screen workspace board moves the launch location of the workspace board; and
Displaying the n workspace boards.

12. The user interface recited in claim 11 wherein the board availability indicator is on the display screen when the workspace board is on screen.

13. The user interface recited in claim 12 wherein the board availability indicator is a handle icon.

14. The user interface recited in claim 11 wherein movement of the workspace board is linear.

15. The user interface recited in claim 11 wherein a new board availability indicator automatically appears on the display screen when a workspace board area is opened.
